(19) United States
(12) Patent Application Publication
(10) Pub. No.: US 2012/0246917 A1
(43) Pub. Date: Oct. 4, 2012

(54) CONTINUOUS PRESS APPARATUS FOR ELECTRODE BAND PLATE

(75) Inventors: Shinji Dairen, Tokyo (JP); Nobuhiro Tazoe, Tokyo (JP); Akihiro Nomura, Tokyo (JP); Hisashi Honjo, Tokyo (JP)

(73) Assignee: IHI CORPORATION, Tokyo (JP)

(21) Appl. No.: 13/425,494

(22) Filed: Mar. 21, 2012

(30) Foreign Application Priority Data
Apr. 1, 2011 (JP) 2011-081909

(51) Int. Cl. H01M 4/04; B21B 31/16; B21B 39/02; B21B 37/72

(52) U.S. Cl. 29/731; 72/8.8; 72/249; 72/250

(57) ABSTRACT

A continuous press apparatus presses an electrode band plate having a band-shaped metal foil collector on which an electrode active material is formed at intervals in a longitudinal direction. The apparatus includes a pair of press rollers, gap adjusting means for adjusting a gap between the press rollers, detecting means for detecting that a rear end of the electrode active material portion arrives at the position between the press rollers, and the gap adjusting means adjust the gap between the press rollers in response to the detection.

### BACKGROUND OF THE INVENTION

1. Technical Field of the Invention

The present invention relates to a continuous press apparatus for an electrode band plate that is used in a lithium-ion battery or the like.

2. Description of the Related Art

A secondary battery such as a lithium-ion battery is configured as follows. An electrode band plate where an electrode active material has been applied on a band-shaped metal-foil collector is spirally wound via a separator. Then, the wound electrode bands are confined in a cylindrical container. On the container, a positive electrode terminal and a negative electrode terminal are provided. The secondary battery has a large reacting area of the spirally wound electrode band plates, so that a large current can be generated.

As the band-shaped metal foil collector, a metal foil such as copper or aluminum is used. In the case of a lithium-ion battery, metal lithium is used for an electrode active material at a negative electrode, and a mixture of various electrode materials and conductive materials is used for an electrode active material at a positive electrode.

In order to improve battery performance, particles of an electrode active material are firmly bound to a metal foil collector by using a binder to form an electrode band plate. The particles of an electrode active material need to be dispersed in the binder in high density.

To achieve this, the electrode band plate in which an electrode active material is formed on a band-shaped collector made of a metal foil is pressed by a press machine.

Such a press machine is disclosed in the Patent Documents 1, 2 identified below, for example. A press machine related to the embodiment of the present invention described later is disclosed in Patent Document 3.
[Patent Document 1] Japanese Patent Application Laid-Open Publication No. H11-3701
[Patent Document 2] Japanese Patent Application Laid-Open Publication No. H11-260356
[Patent Document 3] Japanese Patent Application Laid-Open Publication No. H10-328710

### SUMMARY OF THE INVENTION

### Technical Problem

However, in the case where an electrode active material is formed at intervals on a band-shaped collector made of a metal foil, the following problem occurs at the time of pressing the electrode active material by using a conventional press machine such as the above-described machine.

As shown in FIG. 1, a level difference X exists between a portion where the electrode active material 2b is formed and a portion where the electrode active material 2b is not formed. When a press roller 34 passes the level difference X, the position of the press roller 34 fluctuates, so that impact acts on the electrode band plate 2, and the electrode band plate 2 tends to be broken.

An object of the present invention is to provide a continuous press apparatus for an electrode band plate that prevents an electrode band plate from being broken by impact caused by the level difference at the time of pressing an electrode band plate in which an electrode active material is formed at intervals.

### Means to Solve the Problem

According to the present invention, there is provided a continuous press apparatus for an electrode band plate that presses an electrode band plate having a band-shaped metal foil collector on which an electrode active material is formed at intervals in a longitudinal direction, comprising:
a pair of press rollers that are arranged so as to face each other, rotate in opposite directions, sandwich the electrode band plate between outer circumferential surfaces thereof, and press the electrode active material while transferring the electrode band plate in the longitudinal direction;
gap adjusting means for adjusting a gap between the press rollers to be larger than a thickness of the metal foil collector and be equal to or smaller than a thickness of the electrode band plate at an electrode active material portion that has been pressed, after the press rollers press an electrode active material portion where the electrode active material has been formed, and before a front end of a next electrode active material portion arrives at a position between the press rollers; and
detecting means for detecting that a rear end of an electrode active material portion arrives at the position between the press rollers;
wherein in response to the detection by the detecting means, the gap adjusting means adjust the gap between the press rollers.

By this configuration, before a next electrode active material portion arrives at the position between the press rollers, the gap between the press rollers is adjusted in the gap-widening direction such that the press rollers are positioned near the surface of the electrode active material portion, and the distance between the press roller and the surface of the electrode active material is made small. Thereby, it is possible to ease impact that is caused by the arrangement that the electrode active material is formed on the band-shaped metal foil collector at intervals in the longitudinal direction. As a result, it is possible to prevent the electrode band plate from being broken by impact caused by the level difference.

Preferably, at the timing that the rear end of the electrode active material portion arrives at the position between the press rollers, the gap adjusting means and the detecting means perform gap control of adjusting the gap between the press rollers to be larger than the thickness of the metal foil collector and be equal to or smaller than the electrode band plate at the electrode active material portion that has been pressed by the press rollers. Thereby, it is possible to ease the impact caused right after the electrode active material passes the position between the press rollers.

Further, it is possible to detect the displacement of the press roller when the level difference on the electrode band plate arrives at the position between the press rollers. Accordingly, in response to this detection signal, it is possible to adjust the gap between the press rollers.

In other words, according to the preferred embodiment of the present invention, when the rear end of the electrode active material arrives at the position between the press rollers, the detecting means detect the displacement of the press roller caused by the level difference between the portion where the electrode active material is formed and the portion where the electrode active material is not formed, and in response to the detection signal from the detecting means indicating the displacement of the press roller, the gap adjusting means adjust the gap between the pair of press rollers.

According to a preferred embodiment of the present invention, the continuous press apparatus for the electrode band plate comprises:
a pair of backup rollers that support the press rollers at the opposite side of the position where the electrode band plate is sandwiched by the press rollers; and
a first oil hydraulic cylinder that presses a shaft case of the backup roller to press the electrode band plate,
wherein shaft cases that rotatably support the press rollers are provided at axial end parts of the press rollers,
the gap adjusting means includes a second oil hydraulic cylinder fixed to the shaft case of one of the press rollers, and
a piston of the second oil hydraulic cylinder presses the shaft case of the other of the press rollers to adjust the gap between the press rollers.

By this configuration, the second oil hydraulic cylinder gives force, in the direction of widening the gap between the press rollers, against the force given by the first oil hydraulic cylinder. Thereby, it is possible to adjust the gap between the press rollers.

According to a preferred embodiment of the present invention, the continuous press apparatus for the electrode band plate comprises:
a pressure detecting unit that detects oil pressure of the first oil hydraulic cylinder; and
pressure adjusting means for adjusting oil pressure of the first oil hydraulic cylinder on the basis of the detection by the pressure detecting unit.

By this configuration, when the press rollers press the electrode active material portion on the electrode band plate, it is possible to detect oil pressure of the first oil hydraulic cylinder. On the basis of this detection, it is possible to adjust the oil pressure to press the entire electrode active material portion with a constant pressure.

The detecting means detect that the front end of the electrode active material portion arrives at the position between the press rollers, and in response to this detection, the gap adjusting means are caused to be in a non-operating state.

By this configuration, on the basis of the detection that the front end or the rear end of the electrode active material portion arrives at the position between the press rollers, it is possible to cause the gap adjusting means to be in an operating state or in a non-operating state. Thus, at the appropriate timing, it is possible to cause the gap adjusting means to be in an operating state or in a non-operating state.

### Advantageous Effects of Invention

As described above, according to the present invention, in the case of continuously pressing the electrode band plate having the metal foil collector on which the electrode active material is formed at intervals, after the electrode active material portion where the electrode active material is formed is pressed, and before the front end of a next electrode active material portion arrives at the position between the press rollers, the gap adjusting means adjust the gap between the press rollers to be larger than the thickness of the metal foil collector and be equal to or smaller than the thickness of the electrode band plate at the electrode active material portion that has been pressed. Thereby, it is possible to obtain an excellent advantage of easing the impact generated each time the level difference arrives at the position between the press rollers. As a result, also in the case where the level difference is large, it is possible to ease the impact, and to prevent the electrode band plate from being broken in pressing the electrode band plate.

### BRIEF DESCRIPTION OF THE DRAWINGS

FIG. 1 shows positions of press rollers at the time of pressing an electrode band plate where an electrode active material is formed at intervals.

FIG. 2 is a simplified diagram of a continuous press apparatus for an electrode band plate according to an embodiment of the present invention.

FIG. 3 shows an entire continuous press apparatus according to an embodiment of the present invention.

FIG. 4A shows a state in which press rollers are pressing a portion (electrode active material portion) of an electrode band plate where an electrode active material has been applied.

FIG. 4B shows a state in which press rollers are pressing a portion (non-applied portion) where an electrode active material has not been applied.

FIG. 4C shows a state in which an electrode active material portion has been pressed, and a next electrode active material portion has not yet arrives at a position between press rollers.

FIG. 5 shows a configuration of a balance control device.

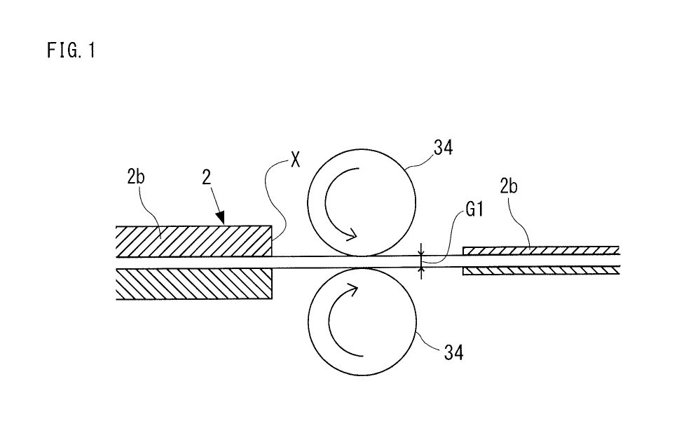

### DESCRIPTION OF EMBODIMENTS

An embodiment of the present invention will be described below with reference to the drawings. The same reference numerals are attached to common parts in each drawing.

A continuous press apparatus for an electrode band plate according to the present invention continuously presses an electrode band plate in which an electrode active material has been applied on one or both of the surfaces of a band-shaped metal foil collector. The band-shaped metal foil collector is a metal foil formed of copper, aluminum or the like, and has a thickness of 10-30 μm, for example. The electrode active material is slurry that is a mixture of a metal powder and electrode materials, a conductive material and a binder. The slurry is coated on one or both of the surfaces of the metal foil collector to have a thickness of 100-200 μm, for example, and is then dried to be solidified, and is then pressed by the apparatus according to the present invention.

In the course in which the slurry as a coating material is applied, pressed and bonded, heating the coating material is effective in that by the heating, the coating material can be easily pressed and bonded, and a crack is less generated in the coating material. Heating the press rollers is also effective, but the description of it is omitted below. According to an embodiment of the present invention, the electrode band plate where the coating material has been applied at intervals is pressed.

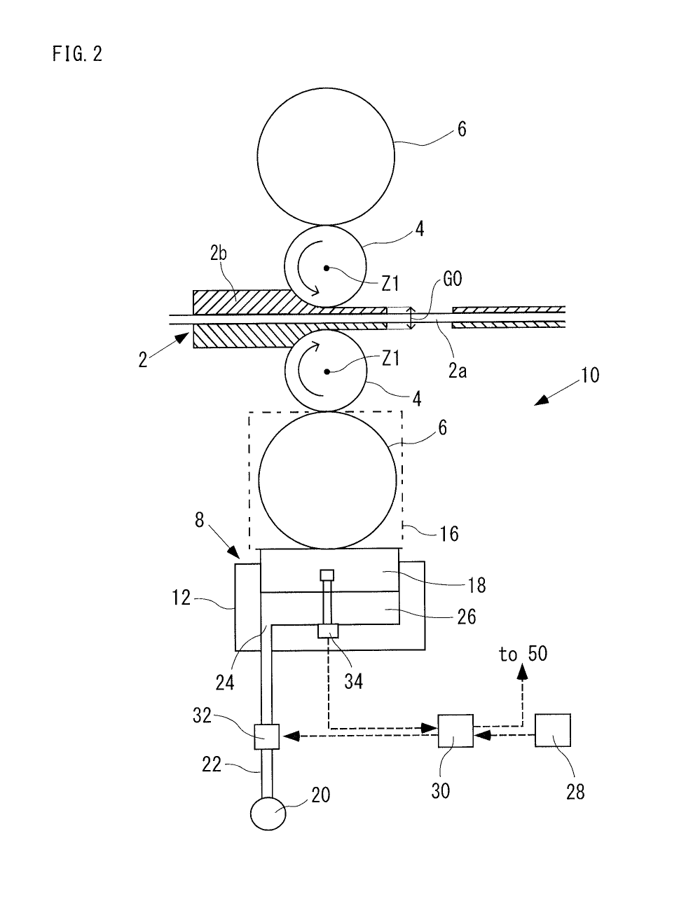

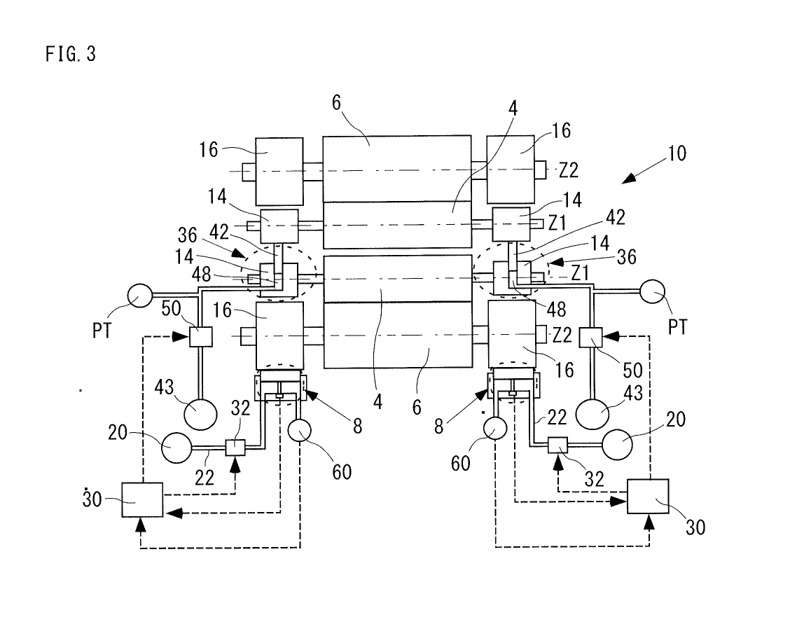

FIGS. 2, 3 are simplified diagrams showing a continuous press apparatus 10 for the electrode band plate according to the embodiment of the present invention.

A pair of press rollers 4 are rotatably supported by bearings at both ends thereof, and are rotated centering axis Z1. The press rollers 4 contact with both surfaces of the electrode band plate 2, respectively. The electrode band plate 2 is pressed between the press rollers 4. The electrode band plate 2 has a band-shaped metal foil collector 2a, and an electrode active material 2b applied to one surface or both surfaces of the collector 2a.

A pair of backup rollers 6 contact with the circumferential surfaces of a pair of the press rollers 4, respectively. Thereby, a radial-direction warp in the press rollers 4 can be reduced.

A diameter of the press rollers 4 is preferably a small value that is not larger than 600 mm. The diameter of the press rollers 4 is preferably set such that the contact angle of the press roller 4 to the electrode band plate 2 is equal to or smaller than 10 degree. A diameter of the backup rollers 6 is preferably equal to or larger than 600 mm. The diameter of the backup rollers 6 is preferably a large value such that a warp at the center part of the press roller 4 is not larger than a predetermined value (for example, 2 μm).

In FIGS. 2, 3, a rotation-driving device (not shown in the drawings) that rotates the axial end part of one of the press rollers 4 around its axis Z1 is provided. Instead of directly rotating the press roller 4, a rotation-driving (not shown in the drawings) that rotates the axil end part of one of the backup rollers 6 around its axis Z2 may be provided. In other words, the backup roller 6 is rotated to rotate the press roller 4 by friction force between the backup roller 6 and the press roller 4.

The reference numeral 8 designates a first oil hydraulic cylinder that is an oil-pressure pressing device. The first oil hydraulic cylinder 8 includes a cylinder body 12 fixed to a housing not shown in the drawings, a piston 18 that supports a shaft case 16 of the backup roller 6 and moves up and down to decrease and increase a gap between a pair of the press rollers 4 and to give pressing force for pressing the electrode band plate 2, and an oil pressure chamber 26 that communicates with an hydraulic pressure source 20 by a pipe 22, and receives and discharge pressurized oil via a pipe opening 24. In this example, the first oil hydraulic cylinder 8 is provided below the shaft case 16 of the backup roller 6 at the lower side. Alternatively, the first oil hydraulic cylinder 8 may be provided above the shaft case 16 of the backup roller 6 at the upper side.

A position instructing unit 28 outputs a position instruction signal to a switching control unit 30 for pressure and position control. In accordance with the position instruction signal, the switching control unit 30 outputs an operation signal to a pressure control valve 32 such as a servo valve. The pressure control valve 32 receives the operation signal, and supplies the pressurized oil to the oil pressure chamber 26 or discharges the pressurized oil from the oil pressure chamber 26 to control pressing force of the oil-pressure pressing device 8. The position of the piston 18 controlled by the pressure control valve 32 is detected by a position detecting unit 34 such as a magnescale. This position detection signal is outputted to the switching control unit 30. On the basis of the above-described position instruction signal and the position detection signal, the switching control unit 30 outputs an operation signal to the pressure control valve 32 to perform feedback control. In this manner, a gap between the press rollers 4 or pressing force of the press rollers 4 can be controlled.

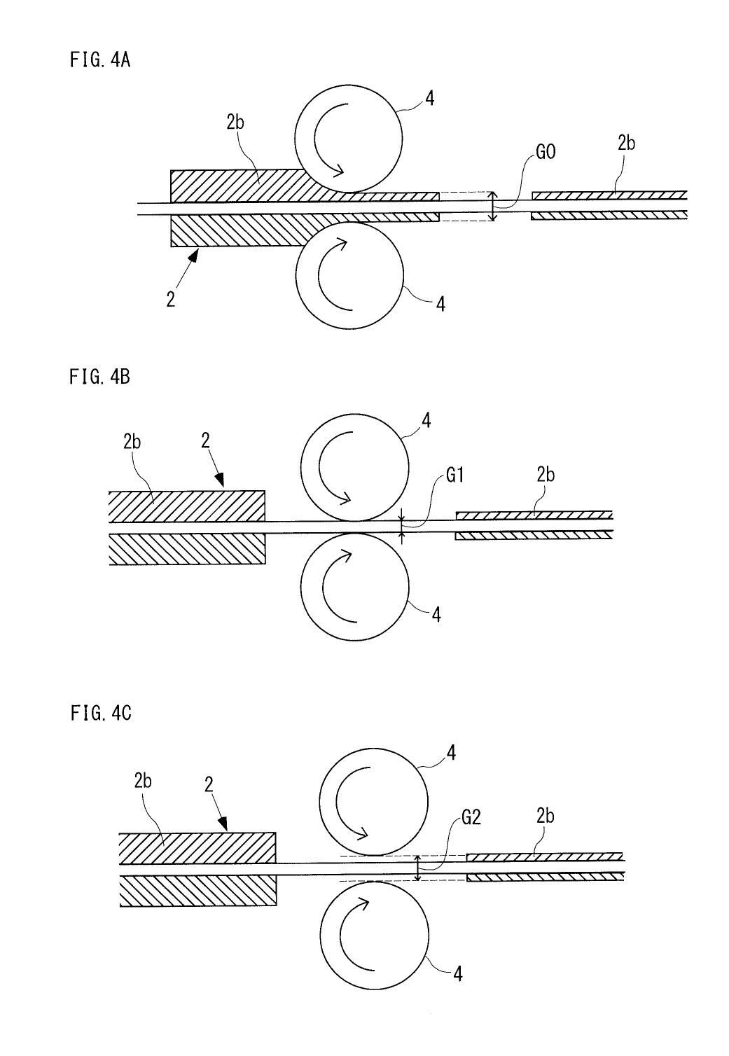

In the following, as shown in FIG. 4A, the reference symbol G0 designates a thickness of the electrode band plate 2 at the portion (electrode active material portion) where the electrode active material 2b has been applied and has been pressed, and as shown in FIG. 4B, the reference symbol G1 designates a thickness of the electrode band plate 2 at the portion (non-applied portion) where the electrode active material 2b has not been applied. G1 designates the thickness of the metal foil collector 2a.

FIG. 4A shows a state in which the press rollers 4 of the press apparatus 10 are pressing the portion in the electrode band plate 2 where the electrode active material 2b has been applied. After the press rollers press the electrode active material portion, the position to be pressed changes from the portion where the electrode active material 2b exists to the portion where the electrode active material 2b does not exist. Accordingly, as shown in FIG. 4B, a gap between the press rollers 4 changes from G0 to G1, or fluctuates near G1. For this reason, when a front end (right end in the figure) of a next electrode active material arrives at the position between the press rollers 4, a gap between the press rollers 4 changes from G1 to G0 at this moment because of the level difference between the electrode active material portion and the portion where the electrode active material does not exist, so that the electrode band plate 2 receives the impact. There are cases in which the impact causes the electrode band plate 2 to be broken.

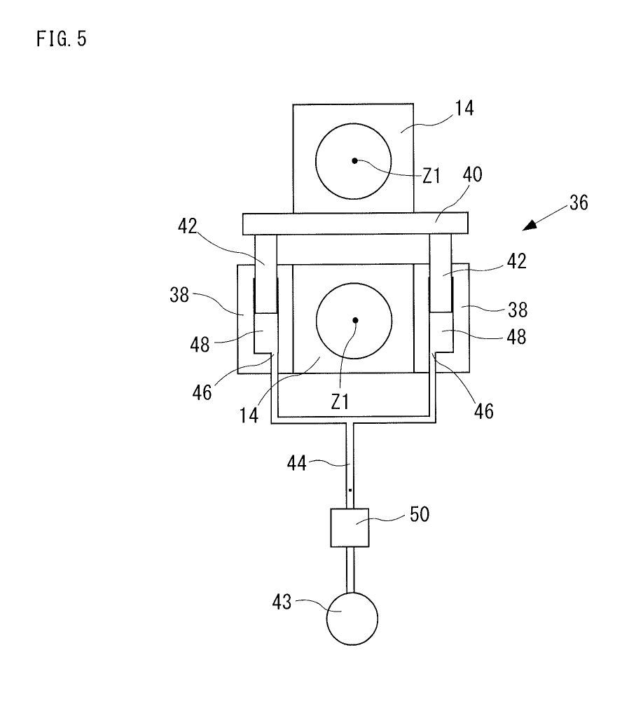

In the view of the above-described matter, according to the embodiment of the present invention, the press apparatus 10 comprises a balance control device 36 that is a second oil hydraulic cylinder. FIG. 5 shows the balance control device 36 seen in the axial direction Z1 of the press roller 4 in FIG. 3. The balance control device 36 includes a cylinder body 38 fixed to the shaft case 14 of the lower-side press roller 4 at both sides as shown in FIGS. 3, 5, a piston 42 that presses the shaft case 14 of the upper-side press roller 4 via a press member 40, an oil pressure chamber 48 of the cylinder body 38 that communicates with an hydraulic pressure source 43 by a pipe 44 and receives or discharges pressurized oil via a pipe opening 46.

### Oil Pressure Control Based on Detection of Rear End of Electrode Active Material

The rear end of the electrode active material portion corresponds to the portion where the electrode active material has not been applied. When the rear end (left end of the electrode active material 2b in FIG. 4A) of the electrode active material portion arrives at the position between the press rollers 4, the position of the piston 18 of the oil-pressure pressing device 8 changes due to the level difference. This position change of the piston 18 is detected by the position detecting unit 34 so that the position detection signal can be outputted to the switching control unit 30.

Instead of the position detecting unit 34, a pressure detecting unit 60 (refer to FIG. 3) that communicates with the oil pressure chamber 26 of the oil-pressure pressing device 8 maybe used to detect pressure change in the oil pressure chamber 26 that is caused by the position change of the piston 18 due to the level difference at the rear end, so that the detection signal indicating the pressure change can be outputted to the switching control unit 30. Alternatively, a pressure detecting unit PT (refer to FIG. 3) such as a pressure transducer that communicates with the oil pressure chamber 48 may be used to detect pressure change in the oil pressure chamber 48 that is caused by the position change of the piston 42 due to the level difference at the rear end, so that the detection signal indicating the pressure change can be outputted to the switching control unit 30.

The switching control unit 30 that received the detection signal indicating the above-described change outputs an operation signal to the pressure control valve 50, as shown in FIG. 3. In accordance with this operation signal, the pressure control valve 50 such as a servo valve supplies, to the oil pressure chamber 48, the pressurized oil for pressing the shaft case 14 of the upper-side press roller 4.

In the above-described example, the rear end of the electrode active material portion is detected by the position detecting unit 34, the pressure detecting unit 60 or the pressure detecting unit PT. Alternatively, another sensor may detect that the rear end of the electrode active material portion arrives at the position between the press rollers 4. In other words, the position detecting unit 34, the pressure detecting unit 60 or the pressure detecting unit PT is configured as the detecting means of the present invention, or other appropriate devices may be used as the detecting means of the present invention.

Gap Control for Portion Where Electrode Active Material does not Exist

When the portion (non-applied portion) where the electrode active material 2b has not been applied arrives at the position between the press rollers 4, the position of the press rollers 4 detected by the position detecting unit 34 can be fed back to the switching control unit 30. In accordance with this feedback signal indicating the detected position, and a desired position previously input to the switching control unit 30, the switching control unit 30 controls an opening degree of the pressure control valve 50 to carry out the position control for the press roller 4. Thereby, the gap between the press rollers 4 is changed to be the gap G2 described later. That is, the desired position corresponds to the gap G2. By such a position control, the time required for recovery process can be shortened when the electrode band plate 2 is broken, for example.

As described above, the control to change the gap between the press rollers 4 to be the gap G2 is carried out in response to the detection by the detecting means that the rear end of the electrode active material portion arrives at the position between the press rollers 4.

Thereby, in FIG. 5, the piston 42 presses the shaft case 14 of the upper-side press roller 4 via the press member 40. In this manner, it is possible to lift the press roller 4 against the press force given by the oil-pressure pressing device 8 to increase a gap of a pair of the press rollers 4. In other words, while the oil-pressure pressing device 8 generates the force for decreasing a gap between the press rollers 4, the balance control device 36 gives, to the press roller 4, the force in the opposite direction so as to adjust a gap between the press rollers 4. Accordingly, it is possible to ease impact generated when the different level portion where the next electrode active material has been applied arrives at the position between the press rollers 4.

The above-described balance control device 36 that is the second oil hydraulic cylinder, the hydraulic pressure source 43, the switching control unit 30, and the pressure control valve 50 constitute gap adjusting means. Alternatively, other appropriate device may be used as the gap adjusting means. The gap adjusting means carry out the following operation.

As shown in FIG. 4C, after the electrode active material portion is pressed, and before the next electrode active material portion arrives at the position between the press rollers 4, the balance control device 36 presses the shaft case 14 of the upper-side press roller 4 such that the gap between the press rollers 4 becomes G2 that satisfies the inequality: G0≧G2>G1. Thus, before the portion where the next electrode active material 2b has been applied arrives at the position between the press rollers 4, the above-described operation is carried out to cause the vertical gap between the press rollers 4 to be larger than G1, and be equal to or smaller than G0. Accordingly, it is possible to prevent the impact from being generated or to ease the impact when the electrode active material portion where the next electrode active material 2b has been applied arrives at the position between the press rollers 4. Since the entire continuous press apparatus 10 can elastically deform, in some cases, it is necessary to set the position of the piston 42 on the basis of the relation among G0, G1 and G2 that was corrected by such elastic deformation.

### Pressurized Oil Control Based on Detection of Front End of Electrode Active Material

When the front end (the right end in FIG. 4C) of the next electrode active material 2b arrives at the position between the press rollers 4, the force for increasing the gap between the press rollers against at the force given by the oil-pressure pressing device 8 becomes a value that is the sum of the force given by the balance control device 36 and the force (reaction force from the pressed electrode active material) given by the thickness of the pressed electrode active material 2b. As a result, when the front end of the next electrode active material 2b arrives at the position between the press rollers 4, the force (reaction force) given by the thickness of the pressed electrode active material 2b cause the position of the piston 18 of the oil-pressure pressing device 8 to change.

This position change is detected by the position detecting unit 34 or the pressure detecting unit 60 as described above. This detection signal is outputted from the position detecting unit 34 or the pressure detecting unit 60 to the switching control unit 30. Alternatively, the pressure detecting unit PT may detect the pressure variation in the oil pressure chamber 48 caused by the position change of the piston 42 that is caused by the level difference at the front end of electrode active material 2b, so that this detection signal can be outputted to the switching control unit 30. Further alternatively, in order to detect that the level difference at the front end of the electrode active material 2b arrives at the position between the press rollers 4, a sensor that detects this front end may be provided as the detecting means of the present invention so that this sensor can output to the switching control unit 30 the detection signal indicating the detection of the level difference.

In response to such a detection signal, the gap adjusting means that are constituted by the balance control device 36, the hydraulic pressure source 43, the switching control unit 30 and the pressure control valve 50 are made in a non-operating state as follows.

In response to the detection signal indicating that the front end of the electrode active material 2b arrives at the position between the press rollers 4, the switching control unit 30 outputs the operation signal to the pressure control valve 50. Thereby, the pressurized oil is discharged from the oil pressure chamber 48 to remove the force that is applied by the piston 42 of the balance control device 36 and that presses the shaft case 14 of the upper-side press roller 4. In this manner, the gap adjusting means are made in a non-operating state, and the pressing force of the press rollers 4 returns to the original value. Then, the press rollers 4 press the portion of the electrode active material 2b. After that, similarly, the gap is maintained to be wide until the front end of a next electrode active material 2b arrives at the position between the press rollers 4. By carrying out the above-described operation, the electrode band plate 2 is pressed.

### Control for Constant Pressing Force

It is preferable to press the portion (electrode active material portion) where the electrode active material 2b has been applied, with a constant pressure. For this reason, the press rollers 4 are controlled to press the portion where the electrode active material 2b has been applied, with a constant pressure. For this constant pressure control, the above-described pressure detecting unit 60 that detects the oil pressure in the oil pressure chamber 26 is provided.

The pressure detecting unit 60 is preferably a pressure transducer, but is not limited to this. The oil pressure value of the oil pressure chamber 26 detected by the pressure detecting unit 60 is fed back to the switching control unit 30. On the basis of the fed back oil pressure value of the oil pressure chamber 26 and a desired pressure value previously input to the switching control unit 30, the switching control unit 30 adjusts an opening degree of the pressure control valve 32. In this manner, the press rollers 4 are controlled to carry out pressing operation with the constant pressure. At this time, the gap adjusting means is in an non-operating state as described above.

According to the embodiment of the present invention, the switching control unit 30 and the pressure control valve 32 constitute the pressure adjusting means of the present invention.

### Other Method of Detecting Front or Rear End of Electrode Active Material Portion

At the upstream side of the press rollers 4, a sensor may detect the front or rear end of the electrode material portion, and on the basis of this detection, may output the detection signal. In this case, this sensor constitutes the detecting means, and the following input method 1 or 2 using this sensor may be adopted.
(1) Input Method 1

The detection signal is input to the switching control unit 30 at the timing that delays from the timing when the sensor detects the front or rear end of the electrode active material portion by the time that the front or rear end of the electrode active material portion takes to move to the position between the press rollers 4.
(2) Input Method 2

The detection signal is input to the switching control unit 30 right before the timing that delays from the timing when the sensor detects the front or rear end of the electrode active material portion by the time that the front or rear end of the electrode active material portion takes to move to the position between the press rollers 4. Thereby, at the timing when the rear end of the electrode active material 2b arrives at the position between the press rollers 4, a gap between the press rollers 4 can be controlled to be G2. As a result, it is possible to ease the impact by the contact of the press rollers 4 and the plate due to gap change from G0 to G1 when the electrode active material 2b completely passes through the position between the press rollers 4.

The sensor that detects the front or rear end of the electrode active material 2b at the upstream side of the press roller 4 may be an optical one, for example. In other words, at very short time intervals, the sensor emits light to the surface of the electrode band plate 2, and detects the reflected light to detect the time period from the timing that the light is emitted to the timing that the reflected light is detected. This time period is different between the case in which the light is reflected by the portion in the surface of the electrode band plate 2 where the electrode active material 2b exists and the case in which the light is reflected by the portion in the surface of the electrode band plate 2 where the electrode active material 2b does not exist. On the basis of this difference, the sensor outputs the detection signal indicating the detection of the front or rear end.

The sensor may be any ones suitable for the embodiment of the present invention. The balance control device 36 is provided at the both sides of the press rollers 4 as shown in FIG. 3. In FIG. 3, the switching control units 30 are provided for different positions, respectively, but one integrated switching control unit 30 may be provided.

The present invention is not limited to the above-described embodiment. The embodiment may be variously modified within the scope of the present invention. For example, the backup roller 4 that supports the press roller is not limited to one that contacts the circumferential surface of the press roller 4, and an intermediate roller (not shown in the drawings) may be provided between the press roller 4 and the backup roller. In this case, the other points may be the same as the above description.

1. A continuous press apparatus for an electrode band plate that presses an electrode band plate having a band-shaped metal foil collector on which an electrode active material is formed at intervals in a longitudinal direction, comprising:
a pair of press rollers that are arranged so as to face each other, rotate in opposite directions, sandwich the electrode band plate between outer circumferential surfaces thereof, and press the electrode active material while transferring the electrode band plate in the longitudinal direction;
gap adjusting means for adjusting a gap between the press rollers to be larger than a thickness of the metal foil collector and be equal to or smaller than a thickness of the electrode band plate at an electrode active material portion that has been pressed, after the press rollers press an electrode active material portion where the electrode active material has been formed, and before a front end of a next electrode active material portion arrives at a position between the press rollers; and
detecting means for detecting that a rear end of an electrode active material portion arrives at the position between the press rollers;
wherein in response to the detection by the detecting means, the gap adjusting means adjust the gap between the press rollers.

2. The continuous press apparatus for an electrode band plate according to claim 1, comprising:
a pair of backup rollers that support the press rollers at the opposite side of the position where the electrode band plate is sandwiched by the press rollers; and
a first oil hydraulic cylinder that presses a shaft case of the backup roller to press the electrode band plate,
wherein shaft cases that rotatably support the press rollers are provided at axial end parts of the press rollers,
the gap adjusting means includes a second oil hydraulic cylinder fixed to the shaft case of one of the press rollers, and
a piston of the second oil hydraulic cylinder presses the shaft case of the other of the press rollers to adjust the gap between the press rollers.

3. The continuous press apparatus for an electrode band plate according to claim 2, comprising:
a pressure detecting unit that detects oil pressure of the first oil hydraulic cylinder; and
pressure adjusting means for adjusting oil pressure of the first oil hydraulic cylinder on the basis of the detection by the pressure detecting unit.

4. The continuous press apparatus for an electrode band plate according to claim 1,
wherein the detecting means detect that the front end of an electrode active material portion arrives at the position between the press rollers, and
in response to this detection, the gap adjusting means are caused to be in a non-operating state.

5. The continuous press apparatus for an electrode band plate according to claim 2,
wherein the detecting means detect that the front end of an electrode active material portion arrives at the position between the press rollers, and
in response to this detection. the gap adjusting means are caused to be in a non-operating state.

6. The continuous press apparatus for an electrode band plate according to claim 3,
wherein the detecting means detect that the front end of an electrode active material portion arrives at the position between the press rollers, and
in response to this detection, the gap adjusting means are caused to be in a non-operating state.
